(19) United States
(12) Patent Application Publication
(10) Pub. No.: US 2002/0104011 A1
(43) Pub. Date: Aug. 1, 2002

(54) Systems and methods for employing opportunistic data transfer to create a dynamically mobile data communication system

(75) Inventors: John M. Svoboda, Idaho Falls, ID (US); David J. Harker, Idaho Falls, ID (US); J. Richard Hess, Idaho Falls, ID (US); Reed L. Hoskinson, Rigby, ID (US)

Correspondence Address: W. Gary Goodson, Bechtel BWXT Idaho, LLC, P. O. Box 1625, Idaho Falls, ID, 83415-3899, US

(73) Assignee: Bechtel BWTX Idaho, LLC

(21) Appl. No.: 09/775,170

(22) Filed: Feb. 1, 2001

(51) Int. Cl. G06F 15/16; G06F 12/14; G06F 11/30; H04L 9/32; H04L 9/00

(52) U.S. Cl. 713/200; 709/227

(57) ABSTRACT

Systems and methods for employing opportunistic data transfer to create a dynamically mobile data communication system. Implementation of the present invention takes place in association with a computer environment with many possible types of computer system configurations such as personal computers, hand-held devices, multi-processor systems, microprocessor-based or programmable consumer electronics, networked PCs, minicomputers, mainframe computers, and the like. Data is automatically compared and replicated between communication nodes when the nodes are within transmission range in order to move the data by creating redundant copies ofthe data. Communication between communication nodes is enabled by one or more network interfaces that include an opportunistic data transfer protocol (“ODTP”) component. Because ODTP components are opportunistic, establishing network connections whenever possible and utilizing the connection for as long as the connection exists, reliable connections are not required to carry out network functions. When a connection is lost, the ODTP component waits for another connection to be established or for a re-connection, in which case the ODTP component will resume from the point that it left off with the previous connection.

### CONTRACTUAL ORIGIN OF THE INVENTION

This invention was made with United States Government support under Contract No. DE-AC07-94ID13223, now Contract No. DE-AC07-99ID13727 awarded by the United States Department of Energy. The United States Government has certain rights in the invention.

### BACKGROUND OF THE INVENTION

1. Field of the Invention

The present invention relates to systems and methods for employing opportunistic data transfer to create a dynamically mobile data communication system. More specifically, the present invention relates to systems and methods that automatically compare and transfer data between communication nodes when the nodes are within transmission range in order to eventually move the data to an intended location. Data that is not stored at each of the communication nodes of a dynamic local area network (“LAN”) is replicated throughout the dynamic LAN and data that is reported as stored at the intended location is deleted throughout the dynamic LAN.

2. Prior State of the Art

The emergence of the information age has caused data transfer to become increasingly important and has resulted in techniques that are employed for transferring data. Such techniques include long range radio frequency (“RF”) links, wire links, and storage devices. The long range RF links include cellular telephone systems, satellite systems, low frequency long range systems, high frequency line-of-sight systems, broad spectrum systems, etc. Wire links include telephone lines and T1 connections. Storage devices include high capacity disk storage devices, floppy disks and data card storage devices.

While these techniques have many advantages when transferring data between computers, the techniques present many drawbacks in mobile, outdoor and/or rural computing environments. If long range RF links are employed in the computing environments, the drawbacks include the purchase of expensive hardware devices and the acquisition of a license from the Federal Communications Commission (“FCC”). Further drawbacks to long range RF links include the expense of operating the systems, the payment of user fees such as in the case of cellular telephone systems, and the difficulty of implementing the systems in rough terrain. If wire links are employed in rural computing environments, the drawbacks include the immobility of the wire links and the propensity of rural telephone lines to be slow and unreliable. If storage devices are employed in mobile, outdoor, rural computing environments, the drawbacks include the requirement for operators to download and upload data and the propensity for system failure in the field environments. These drawbacks presented by the use of the techniques in mobile, outdoor and/or rural computing environments are further compounded as the number of mobile computing connections increase.

### SUMMARY OF THE INVENTION

The present invention relates to systems and methods for employing opportunistic data transfer to create a dynamically mobile data communication system. More specifically, the present invention relates to systems and methods that automatically compare and transfer data between communication nodes when the nodes are within transmission range in order to eventually move the data to an intended location. Data that is not stored at each of the communication nodes of a dynamic LAN is replicated throughout the dynamic LAN and data that is reported as stored at the intended location is deleted throughout the dynamic LAN.

Embodiments of the present invention may take place in a networked environment with many types of computer system configurations such as personal computers, hand-held devices, multi-processor systems, microprocessor-based or programmable electronic devices, networked PCs, minicomputers, mainframe computers, and the like. Junctions or connection points in the networked environment are referred to as communication nodes. A communication node can be mobile (i.e. a laptop computer, a hand-held device, a microprocessor-based electronic device, etc.) or alternatively immobile (i.e. a personal computer, a mainframe computer, etc.). Each communication node includes a storage device, a processor, a communication interface, and a power source.

Communication between communication nodes is enabled by one or more network interfaces that include an opportunistic data transfer protocol (“ODTP”) component, which may be added to existing computerized data collection systems in an analogous manner to local area network (“LAN”) cards and corresponding software to allow for a connectivity of all types of mobile and immobile computer systems to support and create a dynamic LAN. The ODTP component is not restricted on the type of connection that it employs and therefore can utilize an antenna, a cell phone, a telephone line, a network connection, a satellite link, an optical link, etc. for carrying out networking functions.

The ODTP component enables data to be moved to an intended location (i.e. an archival system) by replicating data that is not stored at each of the communication nodes of the dynamic LAN and data that is reported as having been stored at the intended location is deleted throughout the dynamic LAN. In an embodiment of the present invention, the ODTP component gives users “read-only” access to the data and only allows a master archival system to initiate manipulation and/or deletion of data. An embodiment of the present invention also allows for the presence of high priority data to initiate an accelerated contact with a desired location.

Embodiments under the present invention do not require reliable networking connections to carry out network functions. An ODTP component is opportunistic, establishing network connections whenever possible and utilizing the connection for as long as the connection exists. When the connection is lost, the ODTP component waits for a re-connection or another connection to be established and will simply resume from the point that it left off with the last connection.

Additional features and advantages ofthe invention will be set forth in the description that follows, and in part will be obvious from the description, or may be learned by the practice of the invention. The features and advantages of the invention may be realized and obtained by means of the instruments and combinations particularly pointed out in the appended claims. These and other features of the present invention will become more fully apparent from the following description and appended claims, or may be learned by the practice of the invention as set forth hereinafter.

### BRIEF DESCRIPTION OF THE DRAWINGS

In order that the manner in which the above-recited and other advantages and objects of the invention are obtained, a more particular description ofthe invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 illustrates an exemplary system that provides a suitable operating environment for the present invention;

FIG. 2 is a block diagram that illustrates an exemplary configuration for practicing the present invention, where data is compared and replicated among communication nodes;

FIG. 3 is a flow chart that details an exemplary embodiment for opportunistic data transfer among communication nodes in accordance with the present invention;

FIG. 4A illustrates an exemplary embodiment of a dynamically mobile data communication system under the present invention at a first instant in time;

FIG. 4B illustrates the dynamically mobile data communication system of FIG. 4A at a second instant in time;

FIG. 4C illustrates the dynamically mobile data communication system of FIG. 4A at a third instant in time;

FIG. 4D illustrates the dynamically mobile data communication system of FIG. 4A at a fourth instant in time;

FIG. 4E illustrates the dynamically mobile data communication system of FIG. 4A at a fifth instant in time;

FIG. 4F illustrates the dynamically mobile data communication system of FIG. 4A at a sixth instant in time; and

FIG. 4G illustrates the dynamically mobile data communication system of FIG. 4A at a seventh instant in time.

### DETAILED DESCRIPTION OF THE INVENTION

The present invention extends to both methods and systems for employing opportunistic data transfer to create a dynamically mobile data communication system. More specifically, the present invention relates to systems and methods that automatically compare and transfer data between communication nodes when the nodes are within transmission range in order to eventually move the data to an intended location. Data that is not stored at each ofthe communication nodes of a dynamic LAN is replicated throughout the dynamic LAN and data that is reported as stored at the intended location is deleted throughout the dynamic LAN. The embodiments of the present invention may comprise a special purpose or general purpose computer including various computer hardware, as discussed in greater detail below.

Throughout the following disclosure, reference is made to the transferring of data between communication nodes. In the disclosure and in the claims the term “communication node” refers to a junction or connection point in a dynamically mobile data communication system.

Embodiments within the scope of the present invention also include computer-readable media for carrying or having computer-executable instructions or data structures stored thereon. Such computer-readable media can be any available media which can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code means in the form of computer-executable instructions or data structures and that can be accessed by a general purpose or special purpose computer. When information is transferred or provided over a network or another communications connection (either hardwired, wireless, or a combination of hardwired or wireless) to a computer, the computer properly views the connection as a computer-readable medium. Thus, any such a connection is properly termed a computer-readable medium. Combinations of the above should also be included within the scope of computer-readable media. Computer-executable instructions comprise, for example, instructions and data which cause a general purpose computer, special purpose computer, or special purpose processing device to perform a certain function or group of functions.

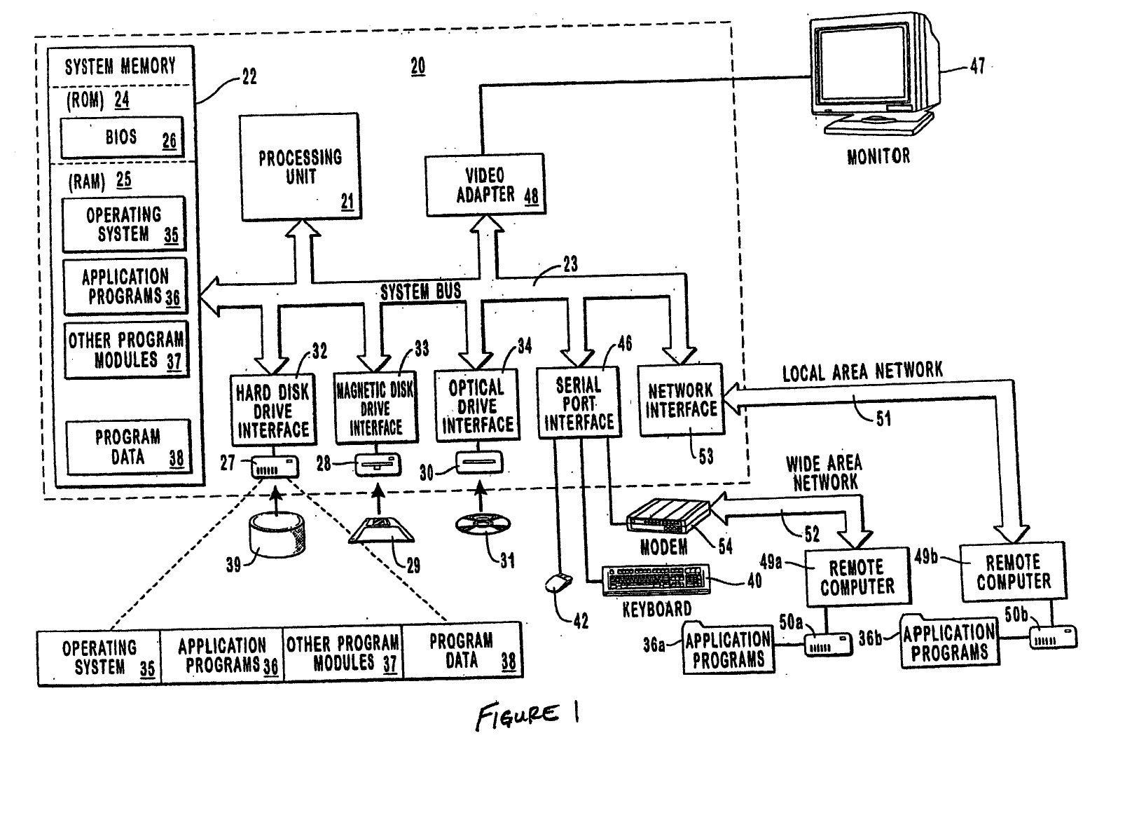

FIG. 1 and the following discussion are intended to provide a brief, general description of a suitable computing environment in which the invention may be implemented. Although not required, the invention will be described in the general context of computer-executable instructions, such as program modules, being executed by computers in network environments. Generally, program modules include routines, programs, objects, components, data structures, etc. that perform particular tasks or implement particular abstract data types. Computer-executable instructions, associated data structures, and program modules represent examples of the program code means for executing steps of the methods disclosed herein. The particular sequence of such executable instructions or associated data structures represent examples of corresponding acts for implementing the functions described in such steps.

Those skilled in the art will appreciate that the invention may be practiced in network computing environments with many types of computer system configurations, including personal computers, hand-held devices, multi-processor systems, microprocessor-based or programmable electronic devices, networked PCs, minicomputers, mainframe computers, and the like. The invention may also be practiced in distributed computing environments where tasks are performed by local and remote processing devices that are linked (either by hardwired links, wireless links, or by a combination of hardwired or wireless links) through a communications network. In a distributed computing environment, program modules may be located in both local and remote memory storage devices.

With reference to FIG. 1, an exemplary system for implementing the invention includes a general purpose computing device in the form of a conventional computer 20, including a processing unit 21, a system memory 22, and a system bus 23 that couples various system components including the system memory 22 to the processing unit 21. The system bus 23 may be any of several types of bus structures including a memory bus or memory controller, a peripheral bus, and a local bus using any of a variety of bus architectures. The system memory includes read only memory (ROM) 24 and random access memory (RAM) 25. A basic input/output system (BIOS) 26, containing the basic routines that help transfer information between elements within the computer 20, such as during start-up, may be stored in ROM 24.

The computer 20 may also include a magnetic hard disk drive 27 for reading from and writing to a magnetic hard disk 39, a magnetic disk drive 28 for reading from or writing to a removable magnetic disk 29, and an optical disk drive 30 for reading from or writing to removable optical disk 31 such as a CD-ROM or other optical media. The magnetic hard disk drive 27, magnetic disk drive 28, and optical disk drive 30 are connected to the system bus 23 by a hard disk drive interface 32, a magnetic disk drive-interface 33, and an optical drive interface 34, respectively. The drives and their associated computer-readable media provide nonvolatile storage of computer-executable instructions, data structures, program modules and other data for the computer 20. Although the exemplary environment described herein employs a magnetic hard disk 39, a removable magnetic disk 29 and a removable optical disk 31, other types of computer readable media for storing data can be used, including magnetic cassettes, flash memory cards, digital video disks, Bernoulli cartridges, RAMs, ROMs, and the like.

Program code means comprising one or more program modules may be stored on the hard disk 39, magnetic disk 29, optical disk 31, ROM 24 or RAM 25, including an operating system 35, one or more application programs 36, other program modules 37, and program data 38. A user may enter commands and information into the computer 20 through keyboard 40, pointing device 42, or other input devices (not shown), such as a microphone, joy stick, game pad, satellite dish, scanner, or the like. These and other input devices are often connected to the processing unit 21 through a serial port interface 46 coupled to system bus 23. Alternatively, the input devices may be connected by other interfaces, such as a parallel port, a game port or a universal serial bus (“USB”). A monitor 47 or another display device is also connected to system bus 23 via an interface, such as video adapter 48. In addition to the monitor, personal computers typically include other peripheral output devices (not shown), such as speakers and printers.

The computer 20 may operate in a networked environment using logical connections to one or more remote computers, such as remote computers 49a and 49b. Remote computers 49a and 49b may each be another personal computer, a server, a router, a network PC, a peer device or other common network node or communication node, and may include many or all of the elements described above relative to the computer 20, although only memory storage devices 50a and 50b and their associated application programs 36a and 36b have been illustrated in FIG. 1. The logical connections depicted in FIG. 1 include a local area network (LAN) 51 and a wide area network (WAN) 52 that are presented here by way of example and not limitation.

When used in a LAN networking environment, the computer 20 is connected to the local network 51 through a network interface or adapter 53. When used in a WAN networking environment, the computer 20 may include a modem 54, a wireless link, or other means for establishing communications over the wide area network 52, such as the Internet. The modem 54, which may be internal or external, is connected to the system bus 23 via the serial port interface 46. In a networked environment, program modules depicted relative to the computer 20, or portions thereof, may be stored in the remote memory storage device. It will be appreciated that the network connections shown are exemplary and other means of establishing communications over wide area network 52 may be used.

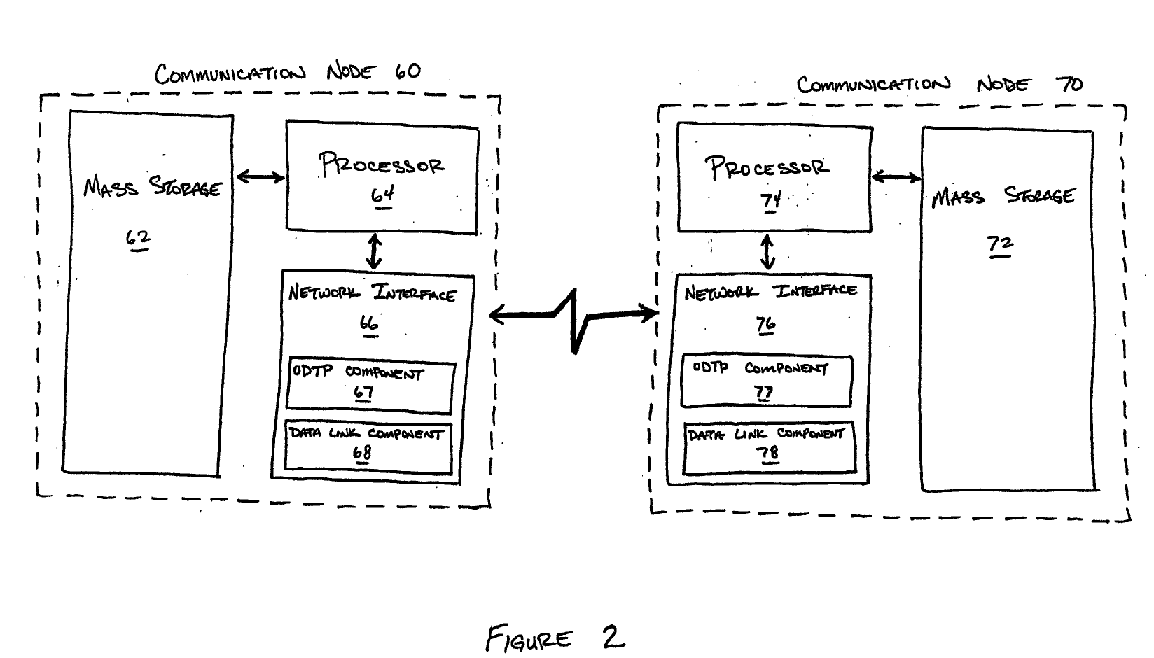

While those skilled in the art will appreciate that the present invention may be practiced in network computing environments with many types of computer system configurations, FIG. 2 illustrates an exemplary configuration for practicing the present invention of comparing and replicating data among communication nodes.

In FIG. 2, communication nodes 60 and 70 are connection points in a dynamically mobile data communication system, which requires two or more communication nodes. A communication node can be, by way of example, a personal computer, a hand-held device, a multi-processor system, a microprocessor-based or programmable electronic device, a networked PC, a minicomputer, a mainframe computer, or the like. Therefore, and also by way of example, computer 20 and remote computers 49a and 49b of FIG. 1 each may be a communication node. Furthermore, a communication node can be mobile (i.e. a laptop computer, a hand-held device, a microprocessor-based electronic device, etc.) or alternatively immobile (i.e. a personal computer, a mainframe computer, etc.).

While communication nodes 60 and 70 communicate with each other via wireless communication, either of communication nodes 60 or 70 may be connected to one or more other communication nodes either by hardwired links, wireless links, or by a combination of hardwired and wireless links.

In FIG. 2, communication nodes 60 and 70 each include a storage device for preserving data, respectively illustrated as mass storage 62 and 72, a processor, respectively illustrated as processors 64 and 74, and a communication interface, respectively illustrated as network interfaces 66 and 76. Each communication node is powered by a power source (not shown), which may include an electrical connection, a battery, one or more solar cells, or the like. By way of example, mass storage 62 and 72 are non-volatile storage media that are capable of storing the data load of the respective information system. Also by way of example, processors 64 and 74 are standard low-power processors that are capable of supporting directory queries and file transfers from a remote communication node to a local mass storage device.

Communication between communication node 60 and communication node 70 is enabled by network interfaces 66 and 76, which further include opportunistic data transfer protocol (“ODTP”) components 67 and 77 and data link components 68 and 78. A data link component may be an Ethernet component, such as a low-power, short-range RF or infrared Ethernet component. An ODTP component may be a Linux-based component that supports standard networking protocols and is capable of taking advantage of the dynamic nature of a mobile computing environment by simultaneously connecting to one or more data link components when in communication range. An ODTP component may be added to existing computerized data collection systems in an analogous manner to LAN cards and corresponding software to allow for a connectivity of all types of mobile and immobile computer systems. ODTP components 67 and 77 in combination with data link components 68 and 78, processors 64 and 74, mass storage 62 and 72, and network interfaces 66 and 76 support and create a dynamic LAN.

One purpose of an ODTP component, such as ODTP components 67 and 77, is to move data. This purpose is accomplished by replicating data throughout a dynamic LAN so that the data will reach an intended location (i.e. an archival system). All communication nodes of the dynamic LAN retain copies of the data until at least one copy of the data reaches the intended location. In one embodiment, the ODTP component gives users and/or communication nodes “read-only” access to the data. Only a master archival system manipulates and/or causes data to be deleted. Therefore, data is only removed from the system when the master archival system receives and confirms that the data is secure at the master archival system and issues a delete command to remove all copies of the secure data from the dynamically mobile data communication system. Each communication node ofthe system deletes the secured data upon receipt of a delete command, which is distributed throughout the communication nodes of the system through the use of ODTP and was originated by the master system, as will be further explained below.

In accordance with the present invention, the ODTP component is not restricted on the type of connection that it employs for carrying out networking functions. By way of example, the ODTP component may employ an antenna, a cell phone, a telephone line, a network connection, a satellite link, an optical link etc. to create a dynamic local area network. However, data may be prioritized and thus high priority data may be transferred directly to a desired location by using a quickly accessible connection, such as, by way of example, a cellular telephone connection upon receipt of the high priority data. The desired location may be the same node within the dynamically mobile data communication system as the intended location (i.e. master archival system) or maybe another communication node. Therefore, a communication node in a dynamically mobile data communication system can have high priority data transferred directly from another communication node in the system through the use of a quickly accessible connection (i.e. cellular telephone or satellite connection). In such an embodiment, high priority data stored in user request files are not deleted until the high priority data is transferred to the desired location.

Embodiments in accordance with the present invention do not require reliable networking connections to carry out network functions. An ODTP component is opportunistic, establishing network connections whenever possible and utilizing the connection for as long as the connection exists. When the connection is lost, the ODTP component waits for a re-connection or another connection to be established. If reconnected, the ODTP component will resume from the point that it left off with the last connection.

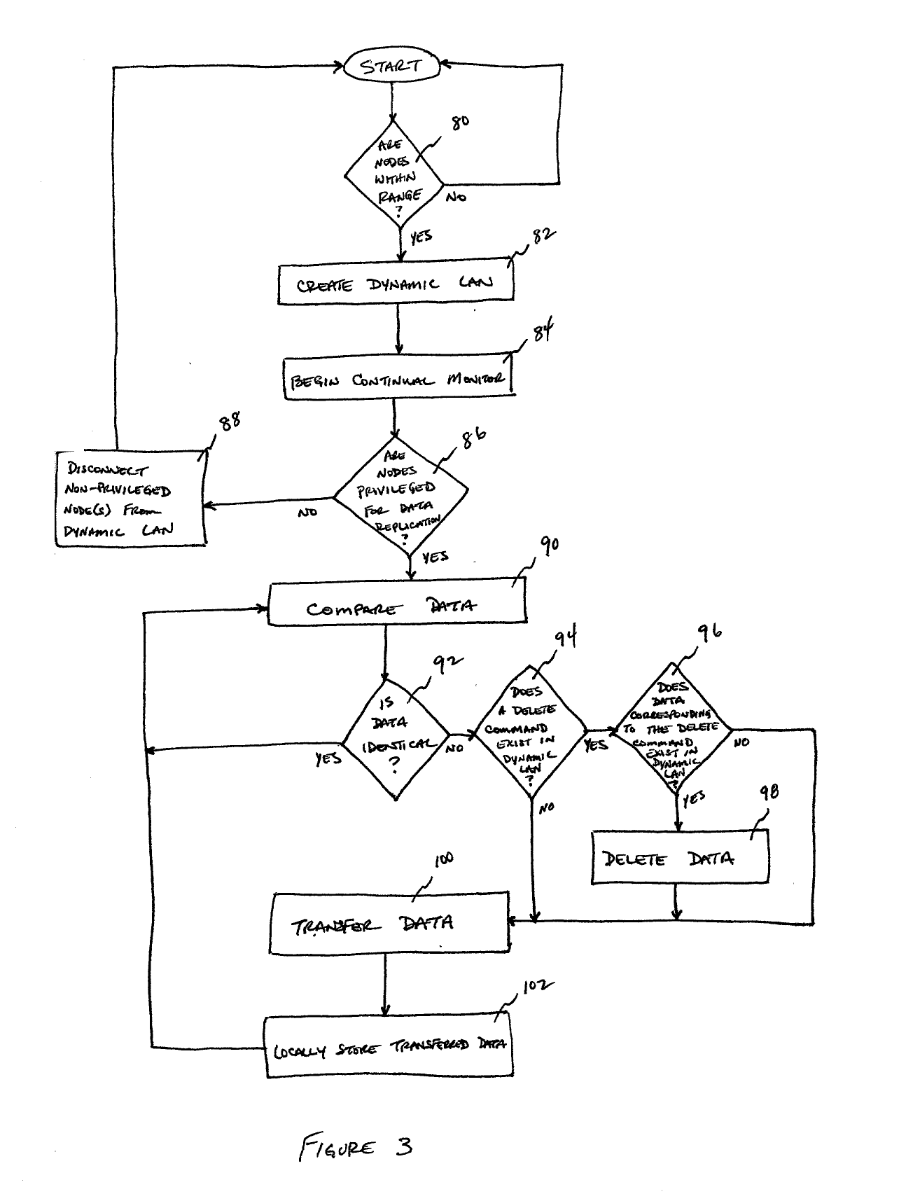

Referring now to FIG. 3, a flow chart is illustrated that details an exemplary embodiment for opportunistic data transfer among communication nodes, such as, communication nodes 60 and 70 of FIG. 2, that have created a dynamic LAN in accordance with the present invention.

In FIG. 3, execution begins with decision block 80, which determines whether or not one or more communication nodes are within communication range. In a dynamically mobile data communication system, all communication nodes listen for all other communication nodes. When any two or more communication nodes are within communication range a dynamic LAN is created in step 82. Alternatively, if decision block 80 determines that a communication node is not within communication range of any other communication node, the communication node that is out of range waits until it is within communication range with one or more other communication nodes.

After a dynamic LAN is created in step 82, a continual monitor is initiated in step 84 to determine whether or not the communication nodes are still within communication range with each other. As mentioned above, embodiments of the present invention do not require reliable networking connections to carry out network functions. An ODTP component creates network connections whenever possible and utilizes the connection for as long as the communication nodes are within communication range. The continual monitor determines whether the communication nodes are still within communication range. If at any instant the communication nodes are out of communication range, execution returns to start and the ODTP component waits for a re-connection or another connection to be established. Otherwise execution continues as illustrated in FIG. 3.

Decision block 86 determines whether or not the communication nodes of the dynamic LAN created in step 82 are privileged for data replication. A communication node is found to be privileged upon identification and authentication. If one or more communication nodes of the dynamic LAN are not privileged, execution proceeds to step 88 with respect to the non-privileged communication node/nodes in order to disconnect the non-privileged communication node/nodes from the dynamic LAN. Alternatively, execution proceeds to step 90 for any two or more communication nodes that are privileged for data replication.

In step 90, the data stored locally at each of the privileged communication nodes of the dynamic LAN is compared. Data is compared by comparing the data directly, by comparing the headers of each packet or file, by comparing file directory information or by a similar comparison method. Decision block 92 then determines whether or not the data compared in step 90 is identical. If the data is identical, execution returns to step 90 so as to continually compare the data so long as the connection between the communication nodes exists. If decision block 92 determines that the data is not identical, execution proceeds to decision block 94 for a determination as to whether or not a delete command that was initiated by the master archival system exists at the one or more communication nodes of the dynamic LAN, as will be further explained below.

As provided above, in one embodiment of the present invention all deletion commands are initiated by a master archival system. Once data is stored at the master archival system, a command is initiated by the master archival system to delete all copies of the stored data throughout the dynamically mobile data communication system and the delete command is propagated throughout the communication nodes through the use of ODTP. Therefore, decision block 94 determines whether or not a delete command, which was initiated by the master archival system, exists at one or more of the communication nodes of the dynamic LAN. If a delete command does not exist at one or more of the communication nodes of the dynamic LAN, execution proceeds directly to step 100.

However, if a delete command exists at one or more of the communication nodes, decision block 96 determines whether or not any of the data that corresponds to the delete command from the master archival system is stored locally at one or more of the communication nodes ofthe dynamic LAN. If no data corresponding to the delete command exists at any one of the communication nodes of the dynamic LAN, execution proceeds directly to step 100. Alternatively, if data corresponding to the delete command exists at any of the communication nodes of the dynamic LAN, the data is deleted at step 98 from all of the communication nodes of the dynamic LAN and then execution proceeds to step 100.

At step 100, data not stored at a privileged communication node is transferred or replicated to the node by either an incremental or complete transfer and is stored locally at the node in step 102. The data transfer performed at step 100 includes providing a local copy at each of the communication nodes of the dynamic LAN of all delete commands initiated by the master archival system and carried by one or more ofthe communication nodes of the dynamic LAN. As long as privileged communication nodes are included in a dynamic LAN, steps 90-102 are executed to cause each of the privileged communication nodes ofthe LAN to store a local copy of all data available within the dynamic LAN. If a privileged communication node of the LAN is no longer within communication range, it is disconnected from the dynamic LAN and waits until it is in range with the same communication node or one or more other communication nodes for the creation of a new dynamic LAN. Upon creating a new dynamic LAN, if the communication nodes were connected previously, the data transfer will continue where it left off.

In a further embodiment of the present invention, the receipt of a delete command causes a privileged communication node to delete the corresponding data unless the data is part of a high priority data file that has not yet been transferred or communicated to the desired location. Therefore, by way of example, in an embodiment of the present invention where data is archived at an intended archival system and when specific data is determined to be a high priority, the high priority data is sent to a separate location to transfer or communicate the high priority data. The high priority data is sent by way of a secure link, such as a cellular link or a satellite link, and is sent as real-time data.

Therefore, by way of example, in an agricultural setting where communication nodes gather data regarding a particular harvest, an embodiment of the present invention includes using opportunistic data transfer to archive a copy of the gathered data at an archival system. Once a copy of the gathered data is archived, the archival system utilizes opportunistic data transfer to disseminate a delete command in order to delete all other copies of the archived data through the system.

If a portion of the gathered data is determined to be high priority data, such as that the moisture content is extremely low, that flooding is occurring, or the like, a communication node initiates the direct transmission of the high priority data or a warning of the presence of high priority data to a location, which may be the archival system or another location such as a farmer's pager, cell phone, laptop computer, or the like. As provided above, the high priority data is transmitted directly over a secure link, such as a cellular or satellite link and the data is transmitted in real-time. Therefore, when a delete command is disseminated by the archival system, and the data to be deleted includes high priority data that should be communicated to a separate location, such as the farmer's cell phone, the high priority data is not deleted until the high priority data is communicated to the farmer's call phone.

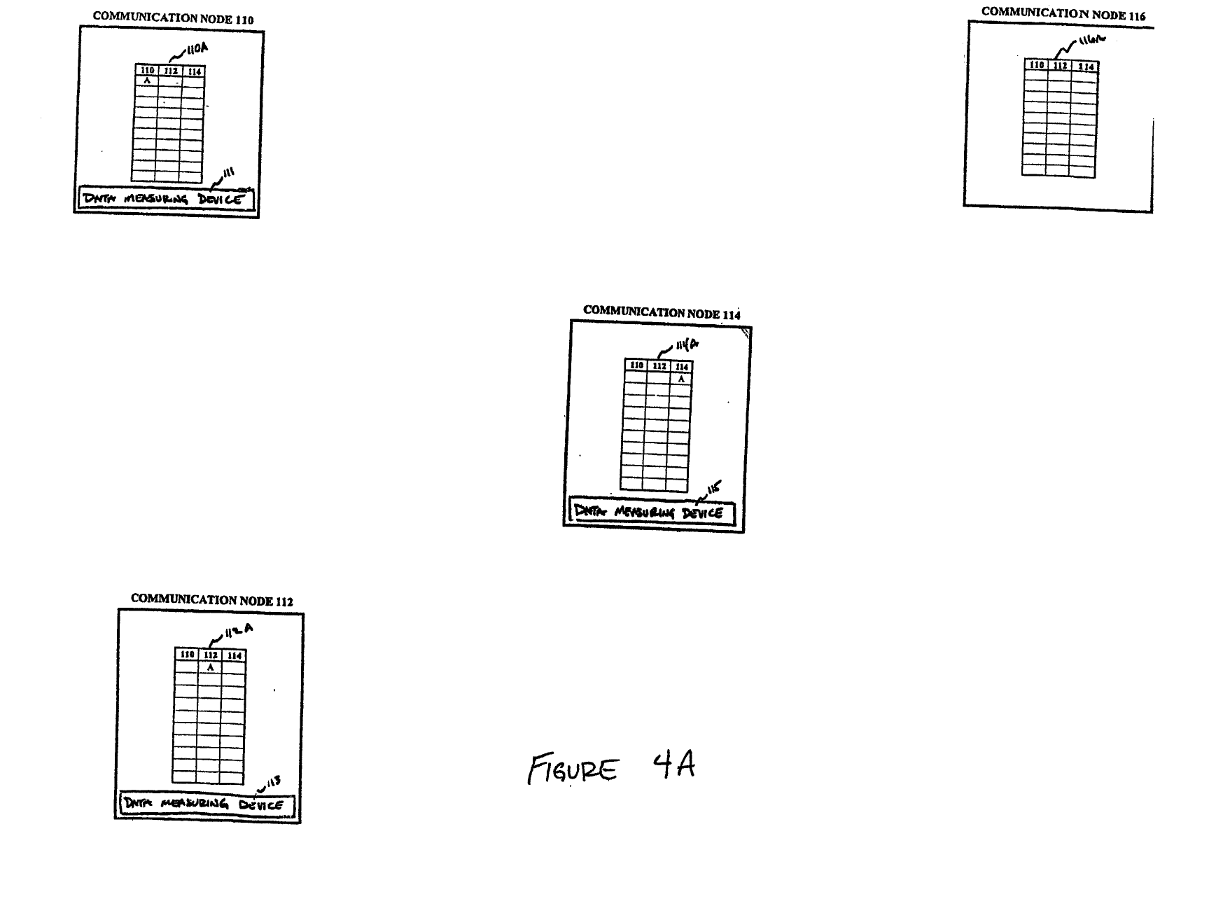

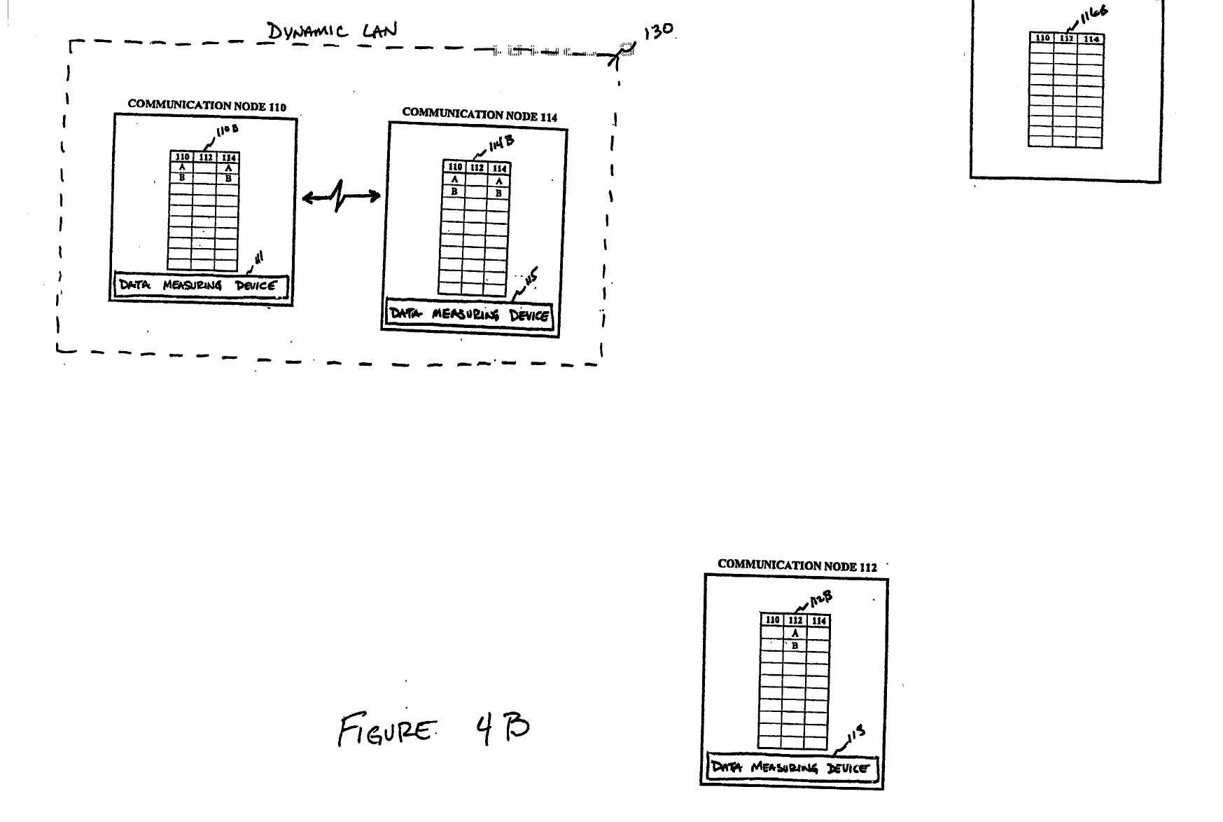

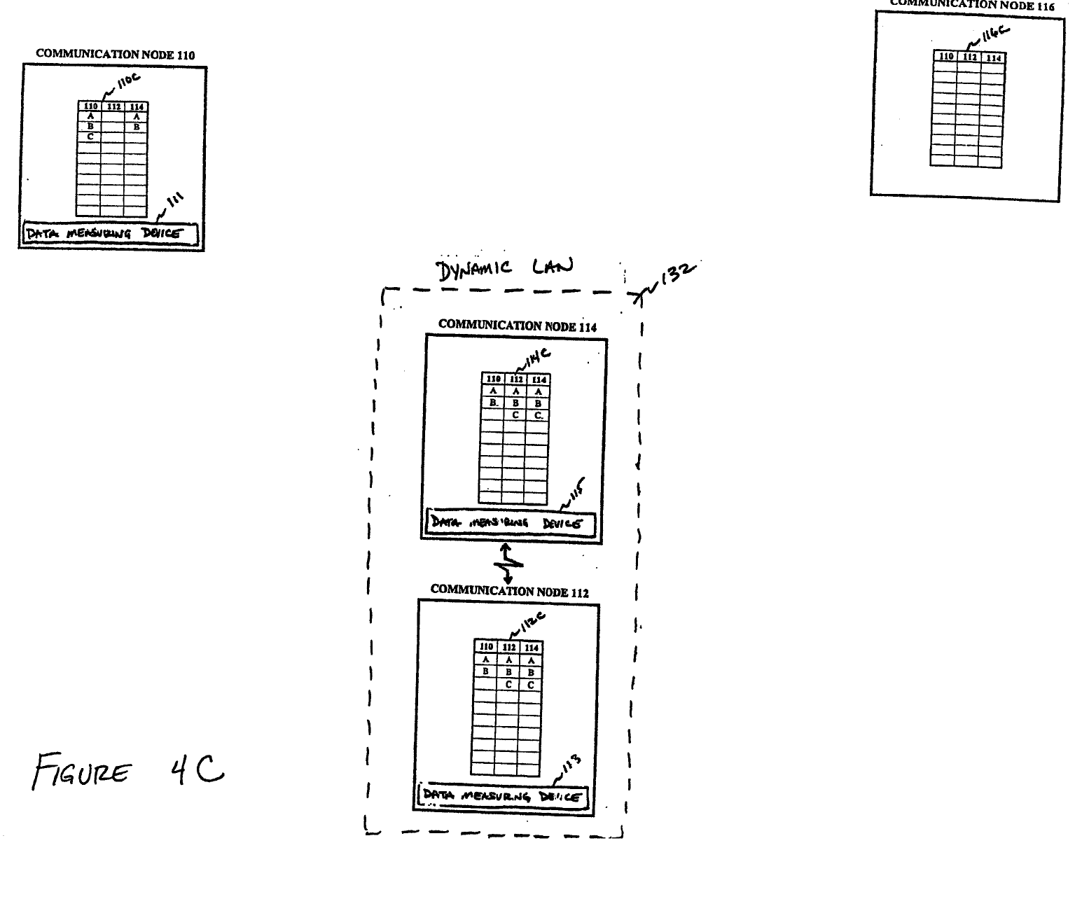

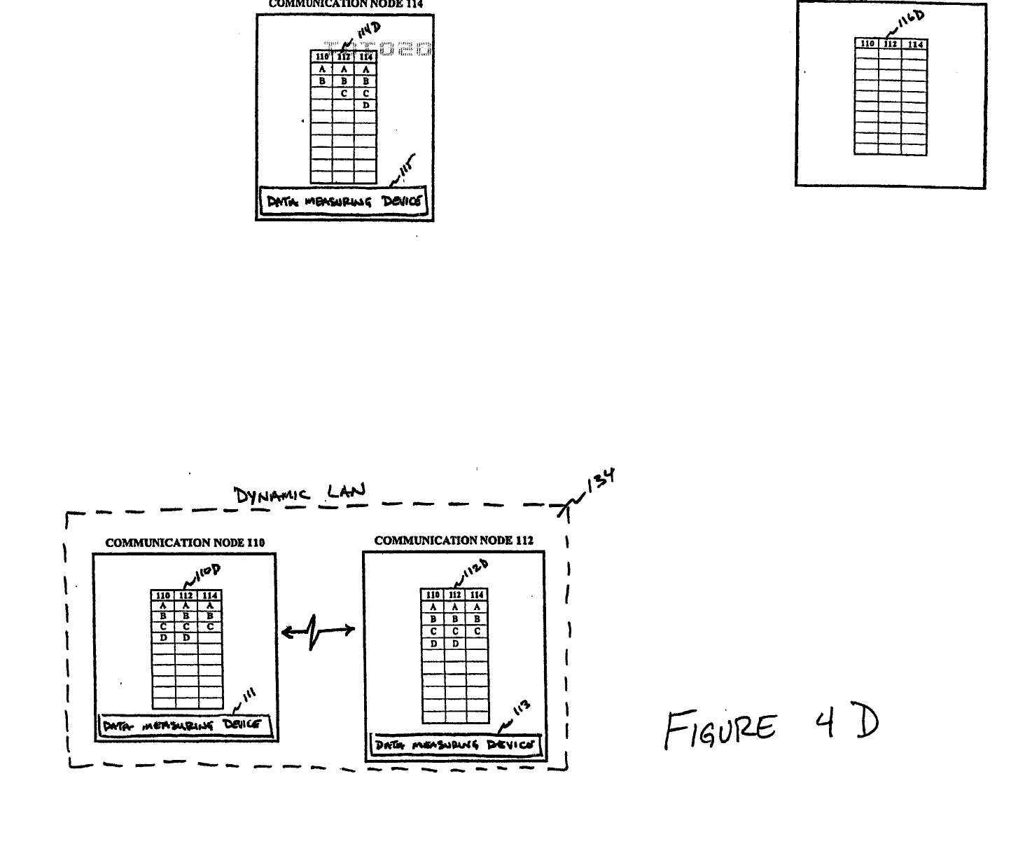

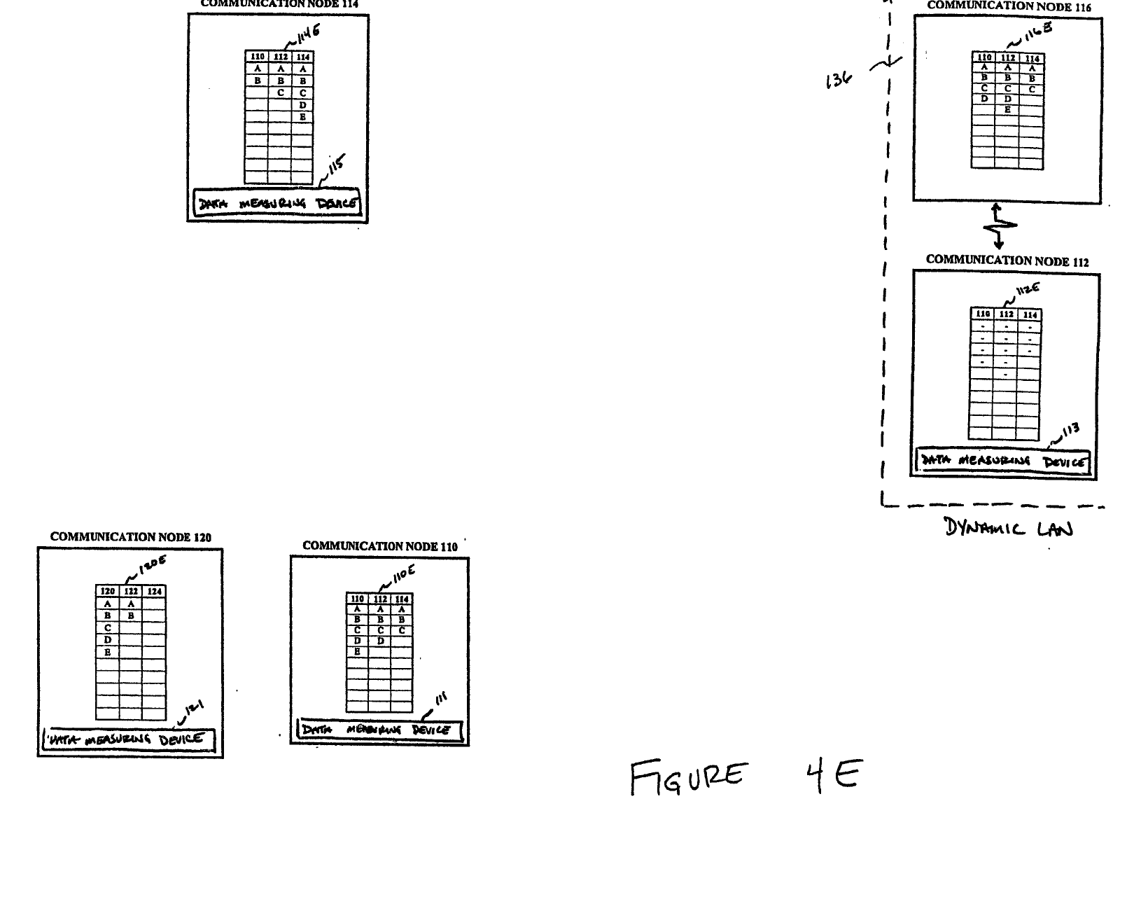

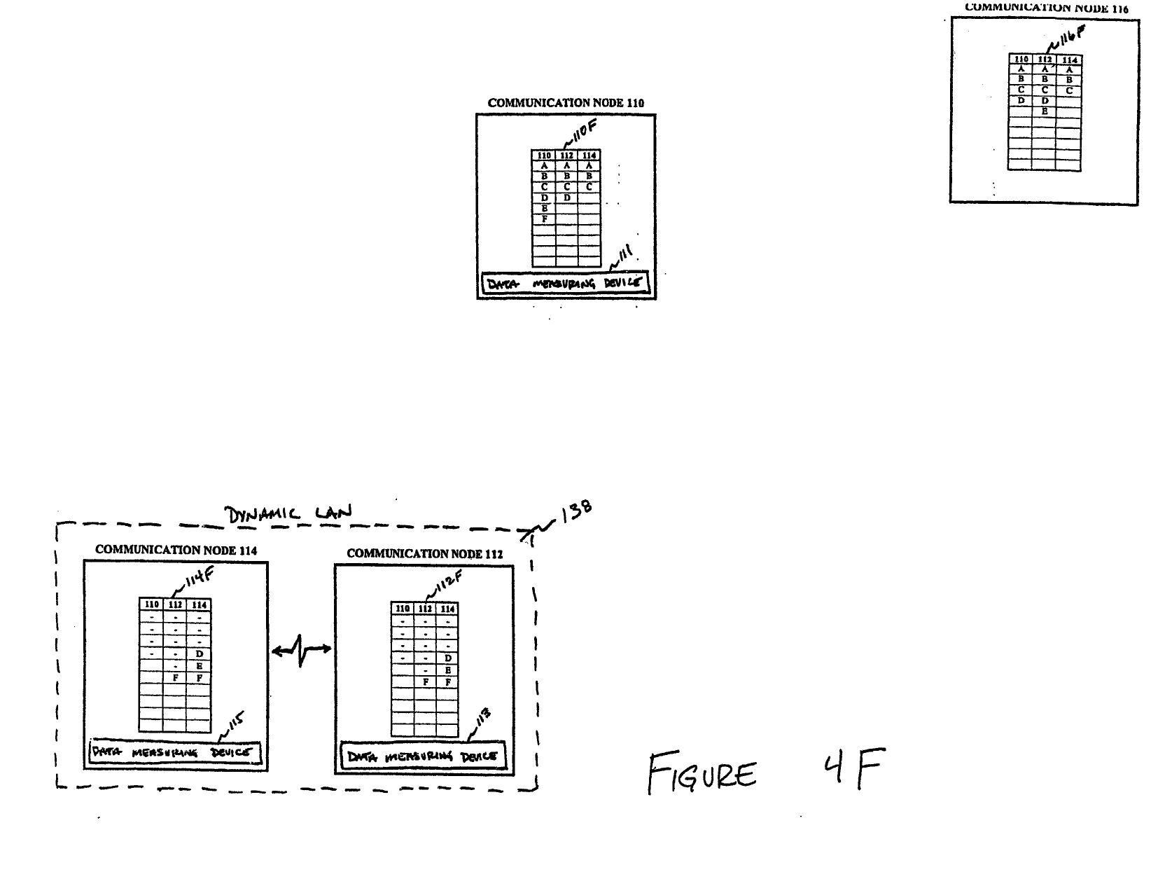

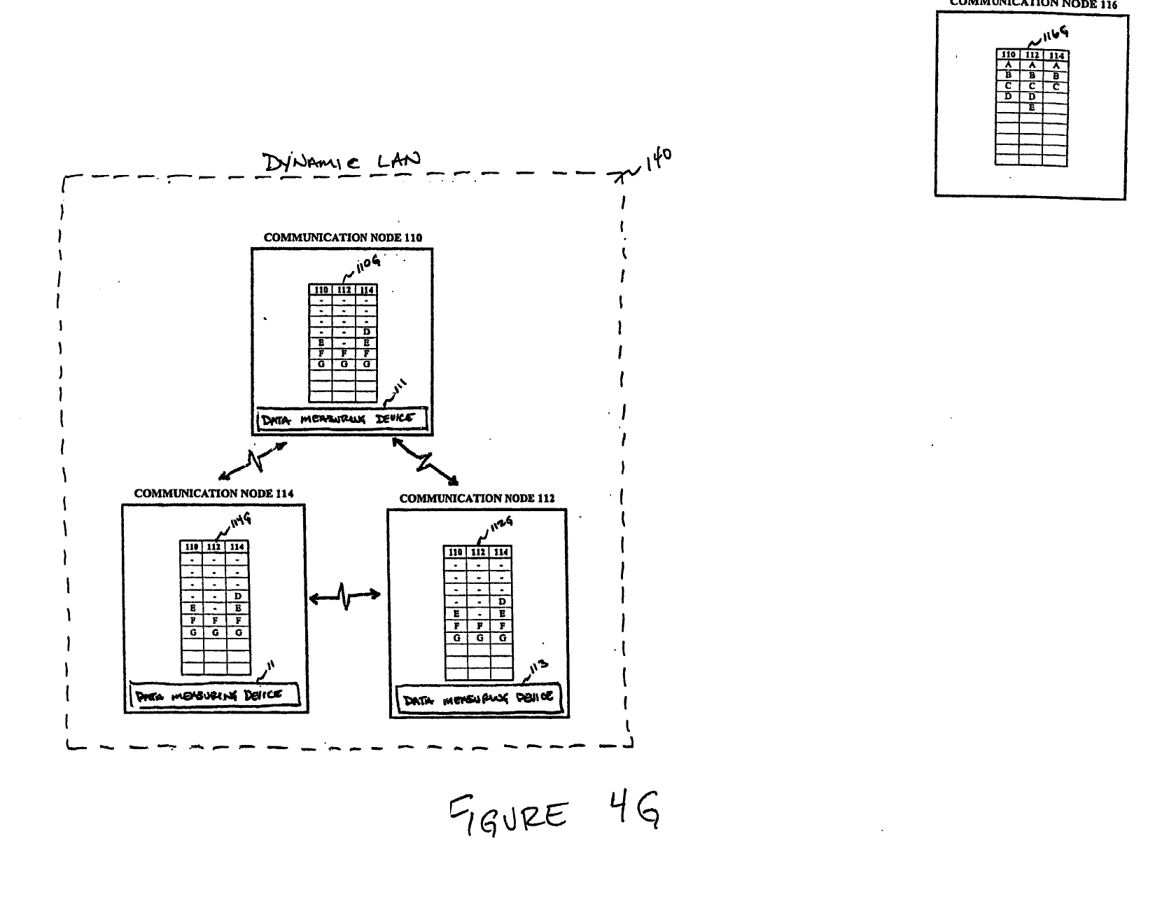

Referring to FIGS. 4A-4G, an example of a dynamically mobile data communication system is illustrated that causes data to be moved to an intended location (i.e. an archival system) in accordance with the present invention. In the illustrated system, a variety of mobile communication nodes having data measuring devices gather, replicate and move data in order for the data to be received by the intended archival system. In the exemplary embodiment of FIGS. 4A-4G the intended archival system is immobile and can be accessed by a variety of computer readable mediums. In another embodiment, the intended archival system may be mobile in order to actively receive or gather the collected data. Upon receipt of the data, the intended archival system initiates copies of the received data to be deleted throughout the dynamically mobile data communication system. (FIGS. 4A-4G illustrate the dynamically mobile data communication system at consecutively progressive instants in time, namely instants A-G in time.)

FIG. 4A illustrates the dynamically mobile data communication system, which includes communication nodes 110, 112, 114 and 116, at an instant “A” in time. In the system, communication nodes 110, 112 and 114 are mobile communication nodes that respectively include data measuring devices 111, 113 and 115 for collecting data. The collected data is intended to be received by an intended archival system, illustrated as communication node 116.

In the illustrated embodiment, each of communication nodes 110, 112, 114 and 116 are similar to communication nodes 60 and 70 of FIG. 2 in that they contain a storage device (not shown), a processor (not shown), and a network interface that includes an ODTP component (not shown).

Each of communication nodes 110, 112, 114 and 116 is illustrated as having a table that indicates the data stored locally at the given instant in time. As explained above, FIG. 4A represents an instant “A” in time. Therefore, the table of each communication node illustrated in FIG. 4A indicates the data that is stored locally in each communication node at time A. In FIG. 4A, the tables are illustrated as tables 110A, 112A, 114A, and 116A, which respectively correspond to communication nodes 110, 112, 114 and 116.

In FIG. 4A, data measuring devices 111, 113 and 115 have collected data that has been locally stored. As illustrated in table 110A, the storage device of communication node 110 includes data gathered by communication node 110 up to an instant A in time. Similarly, table 112A indicates that the storage device of communication node 112 includes data gathered by communication node 112 up to an instant A in time. Also, table 114A indicates that the storage device of communication node 114 includes data gathered by communication node 114 up to an instant A in time. Table 116A indicates that the storage device of communication node 116 (the master or intended system) contains no data since in the illustrated embodiment communication node 116 does not include a data measuring device. FIG. 4A also indicates that no replication of data has occurred because no combination of communication nodes 110, 112, 114 and 116 are in communication range with each other.

FIG. 4B illustrates the dynamically mobile data communication system at an instant “B” in time, which is subsequent to time A. Tables 110B, 112B, 114B and 116B indicate the data stored locally at the corresponding communication nodes at time B. FIG. 4B indicates that data measuring devices 111, 113 and 115 have gathered and locally stored data from time A to time B. Furthermore, communication nodes 110 and 114 are within communication range of each other and thus have created a dynamic LAN (illustrated as dynamic LAN 130), identified and authenticated each other, compared the data stored at each local storage device, transferred data in order to replicate exact copies at each communication node of the most current state of the data, and stored the data locally. This is illustrated by tables 110B and 114B, which indicate that the storage device at communication node 110 and the storage device at communication node 114 contain data collected by communication nodes 110 and 114 up to time B. Alternatively, table 11 2B indicates that the storage device at communication node 112 contains data collected by communication node 112 up to time B. Table 116B indicates that the storage device at communication node 116 (the master or intended system) contains no data.

FIG. 4C illustrates the dynamically mobile data communication system at an instant “C” in time, which is subsequent to time B. Tables 110C, 112C, 114C and 116C indicate the data stored locally at the corresponding communication node at time C. FIG. 4C indicates that data measuring devices 111, 113 and 115 have gathered and locally stored data from time B to time C. Communication nodes 110 and 114 are no longer within communication range of each other and thus the dynamic LAN 130 illustrated in FIG. 4B no longer exists. However, in FIG. 4C communication nodes 112 and 114 are within communication range and thus have created a dynamic LAN (illustrated as dynamic LAN 132), identified and authenticated each other, compared the data stored at each local storage device, transferred data in order to replicate exact copies at each communication node ofthe most current state of the data, and stored the data locally. This is illustrated by tables 112C and 114C, which indicate that the storage device at communication node 112 and the storage device at communication node 114 contain data collected by communication node 110 up to time B, data collected by communication node 112 up to time C, and data collected by communication node 114 up to time C. Table 110C indicates that the storage device at communication node 110 contains data collected by communication node 110 up to time C, and data collected by communication node 114 up to time B. Table 116C indicates that the storage device at communication node 116 (the master or intended system) contains no data.

FIG. 4D illustrates the dynamically mobile data communication system at an instant “D” in time, which is subsequent to time C. Tables 110D, 112D, 114D and 116D indicate the data stored locally at the corresponding communication node at time D. FIG. 4D indicates that data measuring devices 111, 113 and 115 have gathered and locally stored data from time C to time D. Communication nodes 112 and 114 are no longer within communication range of each other and thus the dynamic LAN 132 illustrated in FIG. 4C no longer exists. However, in FIG. 4D communication nodes 110 and 112 are within communication range and thus have created a dynamic LAN (illustrated as dynamic LAN 134), identified and authenticated each other, compared the data stored at each local storage device, transferred data in order to replicate exact copies at each communication node of the most current state of the data, and stored the data locally. This is illustrated by tables 110D and 112D, which indicate that the storage device at communication node 110 and the storage device at communication node 112 contain data collected by communication node 110 up to time D, data collected by communication node 112 up to time D, and data collected by communication node 114 up to time C. Table 114D indicates that the storage device at communication node 114 contains data collected by communication node 110 up to time B, data collected by communication node 112 up to time C, and data collected by communication node 114 up to time D. Table 116D indicates that the storage device at communication node 116 (the master or intended system) contains no data.

FIG. 4E illustrates the dynamically mobile data communication system at an instant “E” in time, which is subsequent to time D. Tables 110E, 112E, 114E and 116E indicate the data stored locally at the corresponding communication nodes at time E. FIG. 4E indicates that data measuring devices 111, 113 and 115 have gathered and locally stored data from time D to time E. Communication nodes 110 and 112 are no longer within communication range of each other and thus the dynamic LAN 134 illustrated in FIG. 4D no longer exists. However, in FIG. 4E communication nodes 112 and 116 are within communication range and thus have created a dynamic LAN (illustrated as dynamic LAN 136), identified and authenticated each other, compared the data stored at each local storage device, transferred data in order to replicate exact copies at each communication node of the most current state of the data, and stored the data locally. This is illustrated by table 116E, which indicates that the storage device at communication node 116 (the master or intended system) contains data collected by communication node 110 up to time D, data collected by communication node 112 up to time E, and data collected by communication node 114 up to time C. Once data was transferred from communication node 112 to communication node 116 and the transferred data was secured, communication node 116 issued a command that all data collected by communication node 110 up to time D, all data collected by communication node 112 up to time E, and all data collected by communication node 114 up to time C has been secured at communication node 116 and thus can be deleted throughout the dynamically mobile data communication system. Therefore, having received the command issued by communication node 116, table 112E indicates that the data collected by communication node 110 up to time D, the data collected by communication node 112 up to time E, and the data collected by communication node 114 up to time C, which was once stored locally at communication node 112 has been deleted. The storage device at communication node 112 now contains no collected data, as indicated by table 112E. Table 110E indicates that the storage device located at communication 110 contains data collected by communication node 110 up to time E, data collected by communication node 112 up to time D, and data collected by communication node 114 up to time C. Table 114 E indicates that the storage device at communication node 114 contains data collected by communication node 110 up to time B, data collected by communication node 112 up to time C, and data collected by communication node 114 up to time E.

FIG. 4E also illustrates communication node 120, which is a communication node of another dynamically mobile data communication system. Table 120E indicates that a storage device at communication node 120 includes data collected by communication node 120 up to time E, data collected by communication node 122 (not shown) up to time B, and no data collected by communication node 124 (not shown). Communication nodes 110 and 120 are within communication range of each other and thus they created a dynamic LAN. However, upon identifying each other communication nodes 110 and 120 were not able to authenticate each other because they did not have privileges for data exchange with each other. Thus, the dynamic LAN created between communication nodes 110 and 120 was disconnected and is not shown in FIG. 4E.

FIG. 4F illustrates the dynamically mobile data communication system at an instant “F” in time, which is subsequent to time E. Tables 110F, 112F, 114F and 116F indicate the data stored locally at the corresponding communication nodes at time F. FIG. 4F indicates that data measuring devices 111, 113 and 115 have gathered and locally stored data from time E to time F. Communication nodes 112 and 116 are no longer within communication range of each other and thus the dynamic LAN 136 illustrated in FIG. 4E no longer exists. However, in FIG. 4F communication nodes 112 and 114 are within communication range and thus have created a dynamic LAN (illustrated as dynamic LAN 138), identified and authenticated each other, compared the data stored at each local storage device, transferred data in order to replicate exact copies at each communication node of the most current state of the data, and stored the data locally. As part of the data transfer, communication node 112 transferred to communication node 114 the command issued by communication node 116, which indicated that the data collected by communication node 110 up to time D, the data collected by communication node 112 up to time E, and the data collected by communication node 114 up to time C has been secured at communication node 116 and thus can be deleted throughout the dynamically mobile data communication system. Therefore, tables 112F and 114F indicate that the storage device at communication node 112 and the storage device at communication node 114 contain no data collected by communication node 110, but do contain data collected by communication node 112 from time E to time F and also data collected by communication node 114 from time C to time F. Table 110F indicates that the storage device located at communication 110 contains data collected by communication node 110 up to time F, data collected by communication node 112 up to time D, and data collected by communication node 114 up to time C. Table 116F indicates that the storage device at communication node 116 (the master or intended system) contains data collected by communication node 110 up to time D, data collected by communication node 112 up to time E, and data collected by communication node 114 up to time C.

FIG. 4G illustrates the dynamically mobile data communication system at an instant “G” in time, which is subsequent to time F. Tables 110G, 112G, 114G and 116G indicate the data stored locally at the corresponding communication nodes at time G. FIG. 4G indicates that data measuring devices 111, 113 and 115 have gathered and locally stored data from time F to time G. Communication node 110 is within communication range of communication nodes 112 and 116 and thus communication nodes 110, 112 and 114 have created a dynamic LAN (illustrated as dynamic LAN 140), identified and authenticated each other, compared the data stored at each local storage device, transferred data in order to replicate exact copies at each communication node of the most current state of the data, and stored the data locally. As part of the data transfer, communication node 110 received the command issued by communication node 116, which indicated that the data collected by communication node 110 up to time D, the data collected by communication node 112 up to time E, and the data collected by communication node 114 up to time C has been secured at communication node 116 (the master or intended system) and thus can be deleted at all other communication nodes throughout the dynamically mobile data communication system. Therefore, tables 110G, 112G and 114G indicate that the storage devices at communication nodes 110, 112 and 114 contain data collected by communication node 110 from time D to time G, data collected by communication node 112 from time E to time G and also data collected by communication node 114 from time C to time G. Table 116F indicates that the storage device at communication node 116 (the master or intended system) contains data collected by communication node 110 up to time D, data collected by communication node 112 up to time E, and data collected by communication node 114 up to time C. Continuation of the exemplary communication system of FIGS. 4A-4G demonstrates that the present invention allows a master or intended system to obtain, with time, all data collected within the dynamically mobile data communication system.

Therefore, in accordance with the present invention, opportunistic data transfer is employed to create a dynamically mobile data communication system, wherein data is automatically compared and transferred between communication nodes when the nodes are within transmission range in order to create a replicate copy of the data and allow the data to be relayed to other nodes within the dynamically mobile data communication system in order that all collected data can be secured by a master or intended system. The present invention may be embodied in other specific forms without departing from its spirit or essential characteristics. The described embodiments are to be considered in all respects only as illustrated and not restrictive. The scope of the invention is, therefore, indicated by the appended claims rather than by the foregoing description. All changes which come within the meaning and range of equivalency of the claims are to be embraced within their scope.

We claim:

1. In a networked communication system that does not require reliable networking connections and which includes a first communication node and a second communication node, wherein the communication nodes employ wireless communication when within communication range, a method for replicating data by employing opportunistic data transfer between the communication nodes to propagate redundant copies of the data, the method comprising the steps for:
using a first monitor at the first node and a second monitor at the second node to determine when the first and second nodes are within communication range, wherein at least one of the first and second nodes is mobile;
creating a dynamic connection between the first and second nodes while in communication range; and
replicating data across the dynamic connection.

2. A method as recited in claim 1, wherein the step for replicating includes comparing data stored locally at the first node with data stored locally at the second node.

3. A method as recited in claim 2, wherein if the data stored at the first node includes information that is not stored at the second node, the step for replicating includes storing a copy of the non-stored information at the second node.

4. A method as recited in claim 3, wherein the non-stored information includes an instruction to delete information.

5. A method as recited in claim 4, wherein the non-stored information includes an instruction to modify information.

6. A method as recited in claim 2, wherein the first node includes a first opportunistic data transfer protocol component and the second node includes a second opportunistic data transfer protocol component.

7. A method as recited in claim 6, wherein the first and second opportunistic data transfer components perform the steps for using the first and second monitors and for creating the dynamic connection.

8. A method as recited in claim 7, further including the steps for:
using the first and second monitors and a third monitor at a third node to determine when the first, second and third nodes are within communication range, wherein the third node includes a third opportunistic data transfer protocol component, and wherein at least one of the first, second and third nodes is mobile; and
including the third node in the dynamic connection.

9. A method as recited in claim 8, wherein the step for replicating data includes replicating data among the first, second and third nodes.

10. A method as recited in claim 9, wherein when at least one ofthe first, second and third nodes is no longer within communication range, excluding the at least one node from the dynamic connection.

11. A method as recited in claim 10, wherein when the at least one node is again within communication range, including the at least one node in the dynamic connection and continuing to replicate data with the at least one node across the dynamic connection.

12. A method as recited in claim 7, wherein when the dynamic connection is disconnected and the first node is within communication range of a fourth node that includes a fourth opportunistic data transfer component and a fourth monitor, performing the steps for:
creating a second dynamic connection between the first and fourth nodes while the nodes are within communication range; and
replicating data across the second dynamic connection.

13. A method as recited in claim 12, wherein the fourth node is an intended archival system that includes a storage device.

14. A method as recited in claim 13, wherein if the data stored at the first node includes information that is not preserved at the fourth node, the step for replicating includes storing an archival copy of the non-preserved information at the fourth node, and wherein when the non-preserved information is stored at the fourth node, initiating instructions from the fourth node to the first node to deleted the non-preserved information.

15. A method as recited in claim 14, wherein the fourth node is mobile.

16. A method as recited in claim 15, wherein when the first and fourth nodes are no longer within communication range, disconnecting the second dynamic connection.

17. A method as recited in claim 16, wherein when the first node is within communication range with a fifth node that includes a fifth monitor and a fifth opportunistic data transfer protocol component, performing the steps for:
creating a third dynamic connection between the first and fifth nodes while in communication range; and
replicating data across the third dynamic connection, including deleting any non-preserved information at the fifth node.

18. A method as recited in claim 17, wherein the second and fifth nodes are the same node.

19. A dynamically mobile data communication system for use in moving data and facilitating the arrival of data at an intended archival location, the system comprising:
a plurality of communication nodes capable of employing wireless communication, wherein at least one of the nodes is mobile;
a storage device located at each of the nodes; and
an opportunistic data transfer protocol component located at each of the nodes, wherein when two or more of the nodes are within communication range, the component at each of the two or more nodes creates a dynamic connection for communication among the two or more nodes so long as the two or more nodes are within communication range.

20. A dynamically mobile data communication system as recited in claim 19, wherein at least one of the plurality of communication nodes is an intended archival system.

21. A dynamically mobile data communication system as recited in claim 20, wherein at least one of the plurality of communication nodes gathers data.

22. A dynamically mobile data communication system as recited in claim 21, wherein when the dynamic connection is created between at least two nodes of the plurality of nodes, data is replicated among the at least two nodes to provide a redundant copy of data at each of the at least two nodes.

23. A dynamically mobile data communication system as recited in claim 22, wherein the data is transmitted in segments.

24. A dynamically mobile data communication system as recited in claim 22, wherein the intended archival system propagates an instruction to one or more nodes of the plurality of nodes to delete data from each of the one or more nodes.

25. A dynamically mobile data communication system as recited in claim 24, wherein the instructions to delete are propagated upon creating a subsequent dynamic connection between two or more nodes of the plurality of nodes, wherein at least one of the two or more nodes includes the instruction to delete and issues the instruction to each of the two or more nodes of the subsequent dynamic connection.

26. A dynamically mobile data communication system as recited in claim 25, wherein when high priority data is gathered, transmitting the high priority data to a desired location through the use of a secure link.

27. A dynamically mobile data communication system as recited in claim 26, wherein the secure link includes one of a cellular link and a satellite link.

28. A dynamically mobile data communication system as recited in claim 27, wherein the high priority data is transferred in real-time.

29. A computer program product for implementing a method of opportunistic data transfer in a dynamically networked system, the computer program product comprising:
a computer-readable medium carrying computer executable instructions for performing the method, wherein the method comprises the steps for:
determining whether a first communication node and a second communication node are within communication range, wherein if the first and second nodes are within communication range, performing the steps for:
creating a dynamic network between the first and second nodes;
determining whether the first and second nodes are privileged for data replication;
if the first and second nodes are determined to be privileged for data replication, performing the steps for:
comparing data stored at the first node with data stored at the second node;
if the data stored at the first node includes information that is not stored at the second node, replicating the non-stored information for storage at the second node; and
if the data stored at the second node includes information not included in the data stored at the first node, transferring the non-included information for storage at the first node; and
if the first and second nodes are not determined to be privileged for data exchange, performing the step for disconnecting the dynamic network.

30. A computer program product as recited in claim 29, wherein the non-stored information and the non-included information include one or more commands to modify data.

31. A computer program product as recited in claim 30, wherein the commands to modify include one or more commands to delete data.

32. A computer program product as recited in claim 31, wherein the step for comparing data includes comparing data headers.

33. A computer program product as recited in claim 31, wherein the step for comparing data includes comparing file directory information.

34. A computer program product as recited in claim 31, wherein the method further comprises the steps for:
determining whether data is high priority data; and
if the data is high priority data, using a secure link to transmit the high priority data to an intended location.

35. A computer program product as recited in claim 34, wherein the secure link includes one of a cellular link, and a satellite link.

36. In a dynamic communication system that includes a plurality of communication nodes, where at least one of the nodes is mobile, a method for replicating data by employing opportunistic data transfer, the method comprising the acts of:
determining whether a first communication node and a second communication node are within communication range, wherein the first communication node is mobile; and wherein if the first and second nodes are within communication range, performing the acts of:
creating a dynamic network between the first and second nodes;
determining whether the first and second nodes are privileged for data replication;
if the first and second nodes are determined to be privileged for data replication, performing the acts of:
comparing data stored at the first node with data stored at the second node;
if the data stored at the first node includes information that is not stored at the second node, replicating the non-stored information for storage at the second node; and
if the data stored at the second node includes information not included in the data stored at the first node, transferring the non-included information for storage at the first node; and
if the first and second nodes are not determined to be privileged for data exchange, performing the act of disconnecting the dynamic network.

37. A method as recited in claim 36, wherein the non-stored information and the non-included information include one or more commands to modify data.

38. A method as recited in claim 37, wherein the one or more commands to modify data include one or more commands to delete data.

39. A method as recited in claim 38, wherein the step for comparing data includes comparing data headers.

40. A computer program product as recited in claim 39, wherein the method further comprises the steps for:
determining whether data is high priority data; and
if the data is high priority data, using a secure link to transmit the high priority data to an intended location.

41. A computer program product as recited in claim 40, wherein the secure link includes one of a cellular link, and a satellite link.
